(19) United States
(12) Patent Application Publication
(10) Pub. No.: US 2026/0216622 A1
(43) Pub. Date: Jul. 30, 2026

(54) OIL-GAS-WATER SEPARATION DEVICE AND METHOD FOR OIL-GAS FIELD PRODUCED LIQUID

(71) Applicants: CHINA PETROLEUM & CHEMICAL CORPORATION, Beijing (CN); SINOPEC EXPLORATION & PRODUCTION RESEARCH INSTITUTE, Beijing (CN)

(72) Inventors: Changchao HU, Beijing (CN); Wei LI, Beijing (CN); Jun GONG, Beijing (CN); Pengyuan DING, Beijing (CN); Minghui HAO, Beijing (CN); Xingwang WANG, Beijing (CN)

(21) Appl. No.: 19/146,052

(22) PCT Filed: Apr. 12, 2024
(86) PCT No.: PCT/CN2024/087461

§ 371 Date: Jul. 7, 2025

(30) Foreign Application Priority Data
Apr. 14, 2023 (CN) 202310403097.X

(51) Int. Cl. B01D 17/02; C02F 1/40; C02F 1/461

(52) U.S. Cl. CPC B01D 17/02; C02F 1/40; C02F 1/46109

(57) ABSTRACT

An oil-gas-water separation device has a main container, and a primary separation mechanism for a gas-liquid separation of the oil-gas field produced fluid. The primary separation mechanism has a liquid inlet pipe and a gas-liquid separation unit. A secondary separation zone, a tertiary separation zone and a collection zone are formed in the main container. The oil-gas-water separation device also include a secondary separation mechanism arranged in the secondary separation zone, for performing a primary oil-water separation on an oil-water mixture separated by the gas-liquid separation unit and entering the secondary separation zone; and a tertiary separation mechanism arranged in the tertiary separation zone, having a three-dimensional electrode unit capable of generating an uneven electric field to destabilize an oily produced water separated by the secondary separation mechanism to perform a secondary oil-water separation on the oily produced water.

The present application claims the priority of Chinese patent application No. 202310403097.X entitled “OIL-GAS-WATER SEPARATION DEVICE AND METHOD” and filed on Apr. 14, 2023, the entire content of which is incorporated herein by reference.

### TECHNICAL FIELD

The present invention relates to the technical field of oil-gas-water separation, and specifically to an oil-gas-water separation device for an oil-gas field produced liquid. The present invention further relates to an oil-gas-water separation method for an oil-gas field produced liquid.

### TECHNICAL BACKGROUND

Oil-gas field produced liquid is usually treated through a centralized treatment process. The produced fluid is transported over a long distance to a centralized treatment station for the heating and dehydration. After treatment, the produced fluid that meets the standards is transported back to a water injection station. Such treatment process can lead to problems such as high energy consumption and over-load operation of some stations, failing to meet the water-based treatment requirements in high-water-cut development stage. Therefore, it is desirable to carry out on-site water separation in positions such as wellheads, metering stations, transfer stations or offshore satellite platforms, so that most of the produced fluid can be separated out in advance. The produced fluid is treated on site to meet the standards and re-injected on site. The remaining low-water-cut oil is then transported to the centralized treatment station for dehydration.

At present, a process with three-phase separator is usually adopted for water separation in high-water-cut oil-gas fields. However, the water separation by the existing three-phase separator has low efficiency, high oil content in the produced fluid, and high water content in the crude oil, causing problems for the subsequent oil-water treatment. In addition, the produced water after separation is generally treated through a process with an oil skimming tank and air flotation/hydro-cyclone, which has disadvantages such as long procedure, large land occupation and low treatment capacity, thus failing to realize high-efficiency treatment.

### SUMMARY OF THE INVENTION

In view of the above technical problems, the present invention aims to propose an oil-gas-water separation device and method for oil-gas field produced liquid, which is able to meet requirements on on-site water separation for highly foaming and highly emulsified crude oil produced fluids, thereby achieving efficient separation of oil, gas and water.

According to one aspect of the present invention, an oil-gas-water separation device for an oil-gas field produced liquid is proposed, which comprises a primary separation mechanism for a gas-liquid separation of the oil-gas field produced fluid, comprising a liquid inlet pipe, and a gas-liquid separation unit in communication with the liquid inlet pipe; a main container, in which a secondary separation zone and a tertiary separation zone are formed, the liquid inlet pipe being in fluid communication with the secondary separation zone; a secondary separation mechanism arranged in the secondary separation zone, for performing a primary oil-water separation on an oil-water mixture separated by the primary separation mechanism and entering the secondary separation zone; and a tertiary separation mechanism arranged in the tertiary separation zone, comprising a three-dimensional electrode unit capable of generating an electric field to destabilize an oily produced water separated by the secondary separation mechanism, so as to perform a secondary oil-water separation on the oily produced water, wherein the main container further comprises a collection zone for collecting the separated oil and water.

According to one embodiment, the three-dimensional electrode unit is arranged on a mounting frame fixed at a bottom portion of the main container, and comprises a plurality of electrode plates spaced apart along a longitudinal direction, and a coalescence packing filled between adjacent electrode plates.

According to one embodiment, two adjacent electrode plates are formed as an anode plate and a cathode plate respectively, wherein a surface of the cathode plate is provided with an insulating coating mixed with conductive filler, and a number of conductive protrusions.

According to one embodiment, heights of the conductive protrusions relative to the surface of the cathode plate are different from each other.

According to one embodiment, the mounting frame comprises a support portion fixed on the main container, and a support plate mounted on the support portion, wherein a plurality of inlet holes is formed on the support plate to allow the oily produced water to enter the three-dimensional electrode unit from a bottom portion to a top portion thereof.

According to one embodiment, the support plate is further provided with a plurality of ultrasonic elements arranged irregularly, for generating an ultrasonic field.

According to one embodiment, the gas-liquid separation unit is arranged at a top portion of the main container, comprising a cyclone connected to the liquid inlet pipe, a liquid inlet being formed on a side wall of the cyclone for receiving the oil-gas field produced fluid.

According to one embodiment, a separation pipe is arranged at one end of the cyclone away from the liquid inlet pipe, and a cyclone grid filled with a separation packing is arranged in the separation pipe, wherein the cyclone and the cyclone grid are configured to perform a multi-stage liquid removal on the oil-gas field produced fluid.

According to one embodiment, the separation pipe is arranged obliquely and comprises at least one return pipeline in communication with the secondary separation zone.

According to one embodiment, the gas-liquid separation unit further comprises a mist catcher in communication with the separation pipe, wherein a packing layer is provided inside the mist catcher, and the fluid introduced into the mist catcher passes through the packing layer from a bottom portion to a top portion thereof for a mist removal to separate the gas, which is discharged through a gas outlet at the top portion of the mist catcher.

According to one embodiment, the secondary separation mechanism comprises a separation shell arranged at a bottom portion of the secondary separation zone and extending along the longitudinal direction, and a flow channel formed inside the separation shell and filled with a diffusion packing, wherein the liquid inlet pipe extends to an inlet end of the flow channel.

According to one embodiment, a first partition plate extending along a vertical direction is fixedly connected between the top portion of the main container and a top portion of the separation shell, and a second partition plate facing an outlet end of the flow channel is provided at the bottom portion of the main container, wherein the first partition plate and the second partition plate are spaced apart from each other and overlap each other along the vertical direction, forming a water retaining space therebetween, so that the oily produced water separated by the secondary separation mechanism enters the water retaining space and then flows over the second partition plate to enter the tertiary separation zone.

According to one embodiment, the collection zone comprises an oil buffer chamber and a water buffer chamber, wherein a top portion of the secondary separation zone is in communication with the oil buffer chamber, and a top portion and a bottom portion of the tertiary separation zone are in communication with the oil buffer chamber and the water buffer chamber respectively.

According to one embodiment, a third partition plate for separating the tertiary separation zone from the collection zone is fixed at the bottom portion of the main container, and a fourth partition plate for separating the oil buffer chamber from the water buffer chamber is fixed at a bottom portion of the collection zone, wherein heights of the second partition plate, the third partition plate and the fourth partition plate increase sequentially.

According to one embodiment, the collection zone is provided with a substantially L-shaped water distributing pipe, which comprises a first pipe body and a second pipe body perpendicular to and in communication with each other, wherein the first pipe body is vertically fixed at a bottom portion of the water buffer chamber, with a height less than that of the fourth partition plate, and the second pipe body passes through the fourth partition plate and the third partition plate to extend into the tertiary separation zone.

According to one embodiment, the water distributing pipe further comprises a regulator for adjusting a water level of the first pipe body.

According to a further aspect of the present invention, an oil-gas-water separation method is proposed, which is performed by means of the above-mentioned oil-gas-water separation device.

Compared with the prior arts, the present application is able to produce the following technical effects.

The oil-gas-water separation device according to the present invention includes a primary separation mechanism, a secondary separation mechanism and a tertiary separation mechanism, so that the oil-gas field produced fluid entering the main container first undergoes the gas-liquid separation by the primary separation mechanism. The separated oil-water mixture undergoes the primary oil-water separation by the secondary separation mechanism, and then the secondary oil-water separation by the tertiary separation mechanism. The separated oil and water are respectively collected by the collection zone, thus completing the oil-gas-water separation of the produced fluid. Said oil-gas-water separation device can perform multiple separations on the oil-gas field produced fluid with a high water separation efficiency, thus ensuring the separation effect. In the meantime, the oil-gas-water separation device, which has a compact structure and a small volume, can treat high foaming and emulsifying oil-gas field produced fluids with a crude oil density of less than 0.98 g/cm³, a water content of more than 50%, and a salt content less than 250,000 mg/L. With this oil-gas-water separation device, more than 50% of the water in the oil-gas field produced fluid can be separated. The oil content and the suspended matter content in the produced water are both less than 50 mg/L. Therefore, the oil-gas-water separation device according to the present invention can realize the on-site water separation for high foaming and emulsifying produced fluids in oil-gas fields.

### BRIEF DESCRIPTION OF THE DRAWINGS

The present invention will be further described below with reference to the drawings. In the drawings:

FIG. 1 shows an overall structure of an oil-gas-water separation device according to the present invention;

FIG. 2 schematically shows a structure of a three-dimensional electrode unit of a tertiary separation mechanism in the oil-gas-water separation device as shown in FIG. 1, and an electric field generated by the three-dimensional electrode unit; and

FIG. 3 is a plan view showing a cathode plate in the three-dimensional electrode unit.

In the present application, all accompanying drawings are schematic ones, provided to illustrate the principle of the present invention merely, and are not necessarily drawn to actual scale.

### DETAILED DESCRIPTION OF EMBODIMENTS

The technical solutions of the present invention will be further described with reference to the accompanying drawings, so that the above objectives, features, and advantages of the present invention can be understood more clearly. It should be noted that the embodiments of the present invention and the technical features therein may be combined together if there is no conflict.

Many specific details are set forth hereinafter to provide a thorough understanding of the present invention. However, the present invention may also be implemented in a manner different from those described herein. Apparently, the embodiments in the description are only a part of the embodiments of the present invention, rather than all of them.

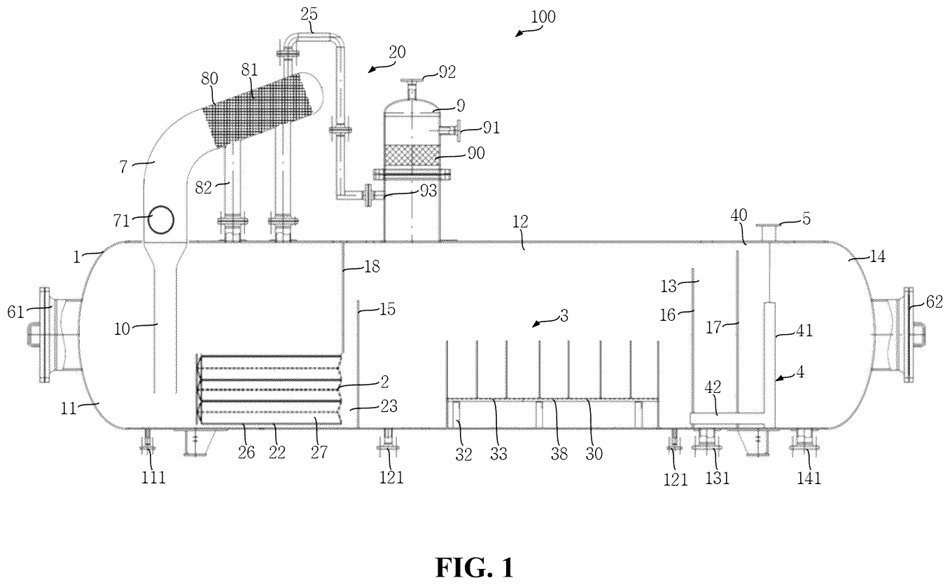

FIG. 1 shows a structure of an oil-gas-water separation device 100 for oil-gas field produced liquid according to the present invention. As shown in FIG. 1, the oil-gas-water separation device 100 includes a main container 1 and a primary separation mechanism 20. A secondary separation zone 11, a tertiary separation zone 12 and a collection zone 40 in communication with each other are formed inside the main container 1. Preferably, as shown in FIG. 1, the secondary separation zone 11, the tertiary separation zone 12, and the collection zone 40 are arranged inside the main container 1 in sequence.

The primary separation mechanism 20, which is configured to separate gas and liquid in the oil-gas field produced fluid, includes a liquid inlet pipe 10 and a gas-liquid separation unit 25 in communication therewith. Preferably, the gas-liquid separation unit 25 is arranged outside a top portion of the main container 1. A first end (i.e., a lower end in FIG. 1) of the liquid inlet pipe 10 extends into the secondary separation zone 11, for transporting oil-water mixture separated by the primary separation mechanism to the secondary separation zone 11 of the main container 1.

A secondary separation mechanism 2 for oil-water separation of the oil-water mixture is arranged in the secondary separation zone 11, and a tertiary separation mechanism 3 for demulsification and separation of oily produced water separated by the secondary separation mechanism 2 is arranged in the tertiary separation zone 12. The collection zone 40, which is configured to collect the separated oil and water, includes an oil buffer chamber 13 and a water buffer chamber 14, wherein a top portion of the secondary separation zone 11 is in communication with the oil buffer chamber 13, and a top portion and a bottom portion of the tertiary separation zone 12 are in communication with the oil buffer chamber 13 and the water buffer chamber 14 respectively.

When the oil-gas-water separation device 100 is in operation, the oil-gas field produced fluid first undergoes gas-liquid separation through the gas-liquid separation mechanism 25 of the primary separation mechanism 20, in order to obtain gas and the oil-water mixture, wherein the separated gas is passed to a mist catcher 9 (see below) of the gas-liquid separation unit 25 for further treatment, and the separated oil-water mixture is passed to the secondary separation zone 11 through the liquid inlet pipe 10. The oil-water mixture entering the secondary separation zone 11 undergoes oil-water separation through the secondary separation mechanism 2 to obtain oil and oily produced water. The separated oil directly enters the oil buffer chamber 13 of the collection zone 40. The separated oily produced water enters the tertiary separation zone 12 and undergoes demulsification and secondary oil-water separation through the tertiary separation mechanism 3, in order to further separate the oil and the produced water, wherein the further-separated oil enters the oil buffer chamber 13 of the collection zone 40, and the further-separated produced water enters the water buffer chamber 14 of the collection zone 40. Thus, the separation of oil, gas and water in the oil-gas field produced fluid is completed.

The oil-water separation device 100 according to the present invention can perform gas-liquid separation once and oil-water separation twice on the produced fluid, which effectively ensures the separation effect and has high water separation efficiency. In the meantime, the entire oil-gas-water separation device has a compact structure and a small volume. Therefore, the oil-water separation device 100 according to the present invention can realize on-site water separation for high foaming and emulsifying oil-gas field produced fluids.

For the sake of convenience, in the present application, the term “longitudinal direction” refers to a direction along a length of the main container 1, for example, a horizontal direction in FIG. 1, the term “vertical direction” refers to a direction along a height of the main container 1, for example, a vertical direction in FIG. 1, and the term “lateral direction” refers to a direction along a width of the main container 1, for example, a direction perpendicular to the plane in FIG. 1.

In one embodiment, the secondary separation mechanism 2 includes a fluid channel member 22 arranged at a bottom portion of the secondary separation zone 11 and extending along a longitudinal direction. Diffusion packing (not shown) may be filled in the fluid channel member 22, and the first end (i.e., the lower end in FIG. 1) of the liquid inlet pipe 10 extends to an inlet end (i.e., a left end in FIG. 1) of the fluid channel member 22. With such structure, the oil-water mixture entering the secondary separation zone 11 through the liquid inlet pipe 10 will flow through the fluid channel member 22 and undergo secondary separation, i.e., primary oil-water separation, under the influence of the diffusion packing.

In one specific embodiment, the fluid channel member 22 includes a separation shell 26 and at least one set of longitudinal partition plates provided therein. When multiple sets of longitudinal partition plates are provided, they are arranged at intervals along a width direction of the separation shell 26, so as to form flow channels 27 therebetween for the oil-water mixture to flow and extending along a length direction of the separation shell 26. Two ends of the separation shell 26 are formed as the inlet end and an outlet end of the fluid channel member 22, respectively. The inlet end of the fluid channel member 22 is located toward a bottom portion of the liquid inlet pipe 10, so that the oil-water mixture can flow into the fluid channel member 22 smoothly. The outlet end of the fluid channel member 22 is in communication with the tertiary separation zone 12, so that the oily produced water separated by the secondary separation mechanism 2 can flow into the tertiary separation zone 12.

A collection chamber (not shown), which is formed between two adjacent sets of the longitudinal partition plates and/or between the longitudinal partition plates and an inner wall of the separation shell 26, is configured to collect the crude oil separated by the secondary separation mechanism 2. The collection chamber is formed at an upper portion of the fluid channel member 22. Preferably, the collection chamber is in communication with the oil buffer chamber 13 through an oil collection pipe (not shown). Specifically, when the oil-water mixture flows in the flow channels 27 of the fluid channel member 22, the oil will float on the surface of the water due to different densities of oil and water. At this time, the oil can flow into the collection chamber through a first outlet hole (not shown) at a top portion of the longitudinal partition plate. Then the crude oil in the collection chamber is output to the oil buffer chamber 13 of the collection zone 40 through the oil collection pipe.

Considering that the oil-water mixture may be mixed with impurities such as soil, solid impurity separation is required to obtain qualified produced water. To this end, at least one transverse partition plate may be arranged in the collection chamber, for dividing the collection chamber into a first collection chamber for collecting the crude oil and a second collection chamber for collecting precipitates, wherein one end of the oil collection pipe is in communication with the first collection chamber. In this manner, when the oil-water mixture flows in the fluid channel member 22, the solid impurities in the oil-water mixture are at the bottom of the fluid. Therefore, a second outlet hole (not shown) may be arranged at a bottom portion of the longitudinal partition plate, so that the solid impurities can flow into a corresponding second collection chamber through the second outlet hole.

Further, a plurality of lateral partition plates inclined relative to the longitudinal partition plates are arranged in each flow channel 27, so that two adjacent lateral partition plates and inner walls of the longitudinal partition plates defining the flow channel together enclose a sub-channel. Therefore, each flow channel is divided into several sub-channels. Preferably, a cross section of each sub-channel is in a shape of a triangle, with a geometric highest point and a geometric lowest point. The second outlet hole is arranged in a position of the longitudinal partition plate corresponding to the geometric lowest point in the cross section of each sub-channel, and each second outlet hole is in communication with a corresponding one of second collection chambers. In an area of each longitudinal partition plate located in the first collection chamber, a first guiding hole in communication with the first collection chamber is arranged in a position of the longitudinal partition plate corresponding to the geometric highest point in the cross section of each sub-channel.

As shown in FIG. 1, a first partition plate 18 is fixedly connected to the top portion of the main container 1, for separating the secondary separation zone 11 from the tertiary separation zone 12. The first partition plate 18 extends downward vertically and terminates above the outlet end of the fluid channel member 22. A second partition plate 15 facing the outlet end of the fluid channel member 22 is arranged at a bottom portion of the main container 1, so that a water retaining space 23 is formed between the outlet end of the fluid channel member 22 (and the first partition plate 18) and the second partition plate 15. The second partition plate 15 is fixedly connected to the bottom portion of the main container 1 and extends upwards along the vertical direction to a position higher than the outlet end of the fluid channel member 22. Thus, the oily produced water separated by the secondary separation mechanism 2 will first enter the water retaining space 23, and then pass over the second partition plate 15 to enter the tertiary separation zone 12. With such structure, the separation effect in the secondary separation zone 11 is greatly enhanced.

According to an embodiment of the present invention, the tertiary separation mechanism 3 includes a mounting frame 30 fixed in the main container 1, and a three-dimensional electrode unit 31 arranged on the mounting frame 30. Specifically, the mounting frame 30 includes a support portion 32 fixed to the main container 1 and a support plate 33 mounted on the support portion 32. The support plate 33 is provided with an insulating layer, and the three-dimensional electrode unit 31 is mounted on the support plate 33. The support plate 33 is further provided with a number of inlet holes (not shown), which are preferably evenly distributed on the support plate 33.

With the electric field generated by the three-dimensional electrode unit 31, the tertiary separation mechanism 3 can destabilize the oily produced water separated by the secondary separation mechanism 2, so that the emulsion in a stable state is demulsified, thereby performing the secondary oil-water separation on the oily produced water. The separated oil floats upwards and flows to the collection zone 40. Thus, the tertiary separation zone 12 is formed as an electric-field demulsification purification compartment.

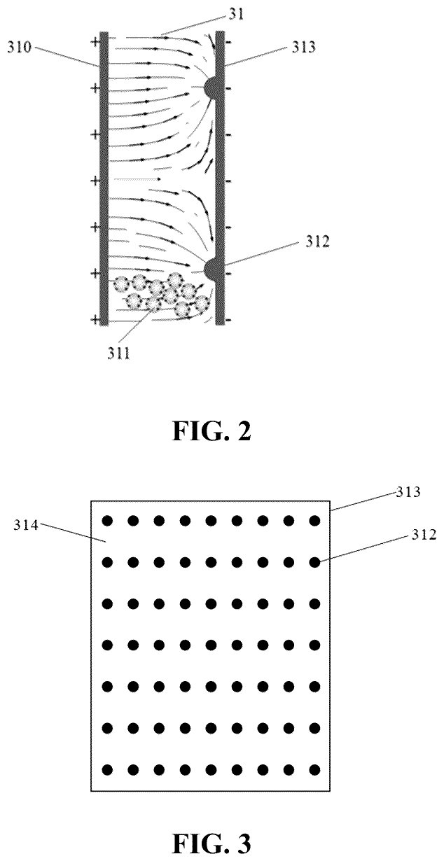

FIG. 2 schematically shows a structure of the three-dimensional electrode unit 31 and an electric field generated thereby. As shown in FIG. 2, the three-dimensional electrode unit 31 includes a plurality of electrode plates arranged at intervals along the longitudinal direction. For the sake of convenience, only two electrode plates arranged at intervals are shown in FIG. 2, wherein the electrode plate on the left is connected to a positive pole of a power supply, forming an anode plate 310, while the electrode plate on the right is connected to a negative pole of the power supply, forming a cathode plate 313. In this manner, an electric-field demulsification zone is formed between the anode plate 310 and the cathode plate 313 adjacent to each other. The oily produced water flows upward through the electric-field demulsification zone from the inlet holes of the support plate 33 for demulsification.

The three-dimensional electrode unit 31 further includes coalescence packing 311 filled between the two electrode plates 310 and 313. According to one preferred embodiment, the coalescence packing 311 may be glass beads that can be polarized in the electric field.

Both the anode plate 310 and the cathode plate 313 may be titanium plate or graphite plate. As shown in FIG. 3, an insulating coating 314 is further coated on a surface of the cathode plate 313. In one preferred embodiment, the insulating coating 314 is mixed with a proportion of conductive packing, with a thickness thereof ranging between 100 to 2,000 μm, generally no less than 500 μm.

According to the present invention, a number of conductive protrusions 312 are further arranged on the cathode plate 313, which form an uneven electric field between the electrode plates 310 and 313 to further enhance the unevenness of the electric field, together with the polarized coalescence packing 311. In this manner, the emulsion can be effectively destabilized, and the collision and coalescence of small oil droplets can be promoted. Therefore, the oil-water separation can be accelerated.

In one preferred embodiment, the conductive protrusions 312 are formed by copper rods, with a cross section thereof ranging from, for example, 10 to 100 mm². A bottom portion of the copper rod is connected to the cathode plate 313, and a top portion thereof is generally no more than 10 mm away from the insulating coating 314.

In another preferred embodiment, the conductive protrusions are arranged on the cathode plate 313 regularly or irregularly. In addition, the heights of the conductive protrusions may be different, in order to further increase the unevenness of the electric field.

As shown in FIG. 1, according to one preferred embodiment of the present invention, the tertiary separation mechanism 3 further includes an ultrasonic element 38. In one preferred embodiment, the ultrasonic element 38 may include a plurality of ultrasonic probes arranged evenly on the support plate 33. The ultrasonic element 38 can generate an ultrasonic field, which act, together with the electric field generated by the three-dimensional electrode unit 31, on the oily produced water flowing through the tertiary separation mechanism 3, thereby further enhancing the demulsification effect. In one preferred embodiment, the ultrasonic element 38 is arranged unevenly on the support plate 33. Therefore, in addition to cooperating with the electric field for demulsification, the ultrasonic element 38 can also prevent scaling or oil film formed on the electrode plates 310 and 313.

According to one preferred embodiment of the present invention, the main container 1 is a horizontal container with opposite first and second ends. Taking FIG. 1 as an example, a first end of the main container 1 is a left end thereof, and a second end of the main container 1 is a right end thereof. The main container 1 may be, for example, cylindrical or cuboid.

The first partition plate 18 is fixedly connected to an inner wall at the top portion of the main container 1 and extends downwards along the vertical direction, while the second partition plate 15, a third partition plate 16 and a fourth partition plate 17 are all fixedly connected to an inner wall at the bottom portion of the main container 1 and extend upwards along the vertical direction. The first partition plate 18, the second partition plate 15, the third partition plate 16 and the fourth partition plate 17 are arranged at intervals along a length direction (a longitudinal direction) of the main container 1. The heights of the second partition plate 15, the third partition plate 16 and the fourth partition plate 17 increase sequentially. A secondary separation zone 11 is formed between the first partition plate 18 and an inner wall at the first end of the main container 1, which works as a lateral water-separation compartment where the primary oil-water separation of the produced fluid is performed. A tertiary separation zone 12 is formed between the first partition plate 18 and the third partition plate 16, which works as a demulsification purification compartment where the secondary separation treatment of the oily produced water is performed to separate oil and water. The oil buffer chamber 13 of the collection zone 40 is formed between the third partition plate 16 and the fourth partition plate 17, which is configured to collect oil.

In this embodiment, the first partition plate 18 extends downwards along the vertical direction, with a lower end thereof fixedly connected to a top portion of the outlet end of the fluid channel member 22. Thus, the oily produced water flowing out from the outlet end of the fluid channel member 22 must flow over the second partition plate 15 to enter the secondary separation zone 12 due to the first partition plate 18, in order to avoid the backflow of the separated oily produced water.

Further, an oil outlet 131 connecting to an oil discharge pipeline (not shown) is provided at a bottom portion of the oil buffer chamber 13, so that the oil is discharged through the oil discharge pipeline and collected, which facilitates the oil collection. The water buffer chamber 14 is formed between the fourth partition plate 17 and an inner wall of a second end of the main container 1, for collecting the separated water. Further, a water outlet 141 is provided at a bottom portion of the water buffer chamber 14, for connecting to a water discharge pipeline (not shown), which facilitates the water discharge. It is readily understood that the position where the water is discharged may be selected according to actual needs.

According to the present invention, as shown in FIG. 1, a substantially L-shaped water distributing pipe 4 is arranged in the collection zone 40 and includes a first pipe body 41 and a second pipe body 42 perpendicular to and in communication with each other. The first pipe body 41 is vertically fixed to the bottom portion of the water buffer chamber 14, and has a height less than that of the fourth partition plate 17. The second pipe body 42, after passing through the fourth partition plate 17 and the third partition plate 16, extends to a bottom portion of the tertiary separation zone 12 and is in communication therewith. In this manner, the oil separated by the tertiary separation mechanism 3 will flow over the third partition plate 16 to enter the oil buffer chamber 13, and the water separated by the tertiary separation mechanism 3 will enter the water buffer chamber 14 through the second pipe body 42 and the first pipe body 41 in sequence. Thus, the water separated in the tertiary separation zone 12 can flow into the water buffer chamber 14 through the water distributing pipe 4. Further, the water distributing pipe 4 may further include a regulator 5 for adjusting a water level of the first pipe body 41.

According to one preferred embodiment of the present invention, maintenance holes for operators to enter and exit may be provided at the first end and the second end of the main container 1 respectively, in order to facilitate the maintenance and cleaning inside the main container 1. The two maintenance holes can be sealed by a first door 61 and a second door 62 respectively, in order to ensure that the main container 1 is in a sealed state during the separation.

According to the present invention, as shown in FIG. 1, a first drain port 111 is provided at the bottom portion of the secondary separation zone 11, and a second drain port 121 is provided at the bottom portion of the tertiary separation zone 12. According to one preferred embodiment, two second drain ports 121 may be arranged in positions on the main container 1 corresponding to two longitudinal ends of the tertiary separation mechanism 3, respectively. These drain ports are used for regular drainage inside the main container 1 to ensure the cleanness thereof.

According to the present invention, as shown in FIG. 1, the gas-liquid separation unit 25 of the primary separation mechanism 20 is arranged at the top portion of the main container 1, and includes a cyclone 7 connected to a second end (an upper end in FIG. 1) of the liquid inlet pipe 10. A liquid inlet 71 for the oil-gas field produced fluid to enter is provided on a side wall of the cyclone 7. In addition, an inclined separation pipe 80 is provided at one end of the cyclone 7 away from the liquid inlet pipe 10, and a cyclone grid 81 is provided in the separation pipe 80. Separation packing is filled in the cyclone grid 81. The oil-gas field produced fluid entering the cyclone 7 through the liquid inlet 71 can pass through the cyclone 7 and the cyclone grid 81 in sequence for multi-stage liquid removal treatment.

The cyclone 7 realizes separation with the principle of centrifugal sedimentation. When the two-phase mixture to be separated enters the cyclone 7 tangentially from the liquid inlet 71 of the cyclone 7 at a certain pressure, a strong three-dimensional elliptical rotating shear turbulent motion is generated. Due to the particle size difference between coarse particles and fine particles, the centrifugal force, centripetal buoyancy and fluid drag force thereon are different. Due to centrifugal sedimentation, most of the coarse particles are discharged through a bottom flow port of the cyclone 7, and most of the fine particles are discharged from an overflow pipe of the cyclone 7, so as to realize separation. Therefore, according to the present invention, the oil-gas field produced fluid enters the cyclone 7 tangentially through the liquid inlet 71, and undergoes gas-liquid separation through the cyclone 7. The separated oil-water mixture enters the secondary separation zone 11 through the liquid inlet pipe 10. The separated gas is discharged from a top portion of the cyclone 7 and introduced into the mist catcher 9 (see below).

Preferably, one end of the separation pipe 80 away from the cyclone 7 is provided with a gas outlet in communication with the mist catcher 9. In this manner, the gas separated by the cyclone 7 enters the separation pipe 80. The cyclone grid 81 can increase the flow paths of the gas. Since the branches of the cyclone grid 81 are in communication with each other, the gas will collide with each other. Therefore, small liquid droplets in the gas also collide with each other and merge into large liquid droplets, thus accumulating at a bottom portion of the separation pipe 80. The gas after secondary separation is discharged through the gas outlet.

Further, the separation pipe 80 is arranged obliquely above the secondary separation zone 11, and provided with a return pipeline 82 in communication with the secondary separation zone 11. In one specific embodiment, an angle between the separation pipe 80 and the horizontal direction is 3 to 50 degrees, preferably 3 to 20 degrees. The bottom portion of the separation pipe 80 is in communication with the secondary separation zone 11 through at least one, preferably a plurality of return pipelines 82, thus forming a cross structure. With such structure, the large liquid droplets can enter the secondary separation zone 11 through the return pipelines 82 and be mixed with the produced fluid entering the secondary separation zone 11 through the liquid inlet pipeline 10, so as to perform subsequent oil-water separation together and avoid waste and pollution.

According to the present invention, the gas-liquid separation unit 25 further includes the mist catcher 9 in communication with the separation pipe 80. As shown in FIG. 1, the mist catcher 9 is arranged at the top portion of the main container 1, and a packing layer 90 is provided inside the mist catcher 9. A gas outlet 92 in communication with a gas collection pipeline is provided at a top portion of the mist catcher 9, and a side area thereof below the packing layer 90 is provided with an inlet end 93 in communication with the separation pipe 80 through a gas-liquid pipeline. Thus, the gas-liquid mixture introduced into the mist catcher 9 passes through the packing layer 90 from a bottom portion to a top portion thereof for mist removal, so as to separate the gas. The gas is discharged into the gas collection pipeline through the gas outlet 92 at the top portion of the mist catcher 9. Thus, the collection of gas is realized.

The inlet end 93 of the mist catcher 9 is in communication with the gas outlet of the separation pipe 80 through the gas-liquid pipeline. The mist catcher 9 is configured to remove and recover the mist (mist droplets) in the gas, or purify the gas to reduce the impurities therein. Therefore, the mist catcher 9 can realize a secondary liquid removal treatment, i.e., mist removal treatment, for the gas separated by the separation pipe 80. The gas after treatment can be discharged to other gas recovery devices through the gas collection pipeline. In one preferred embodiment, the gas after treatment is natural gas. Therefore, the natural gas is preferably transported to a natural gas pipeline for rational use of resources.

Preferably, a safety valve 91 is provided on a side wall of the mist catcher 9. When a gas pressure in the mist catcher 9 is greater than a pressure threshold thereof, the safety valve 91 is turned on to release the pressure, ensuring the safety of the mist catcher 9.

In one specific embodiment according to the present invention, the main container 1 of the oil-gas-water separation device 100 is 6 meter long, with an inner diameter of 1.6 meter. An inner diameter of a straight pipe section of the cyclone 7 is 300 mm. A diameter of a cylinder of the mist catcher 9 is 400 mm. The separation shell 26 of the fluid channel member 22 of the secondary separation mechanism 2 is 1.2 meter long, and a cross section of each sub-channel thereof is an equilateral triangle with a side length of 30 mm. There are ten electrode plates 310 and 313 in total, each of which has a width of 0.8 meter and a height of 0.8 meter. A distance between adjacent plates is 150 mm, with glass balls each with a diameter of 8 mm filled therebetween. The surface of the cathode plate is coated with an epoxy resin coating with a thickness of 500 μm and mixed with graphene.

The above-mentioned oil-gas-water separation device 100 is used to treat the oil-gas field produced fluid with high emulsified oil, which has a crude oil density of 0.90-0.98 g/cm³, a salinity of 220,000 mg/L, and a water content of 85%. A low-voltage DC pulse uneven electric field (voltage 3-1,000V) is used to destroy emulsion film structures of the oil droplets in the oil-gas field produced fluid and induce the migration, collision and coalescence of the oil droplets, in order to realize physical demulsification. No chemicals are added during the treatment procedure. After the treatment by said oil-gas-water separation device 100, the water separation ratio is more than 90%, the oil content in the produced water is less than 30 mg/L, and the suspended matter content is less than 20 mg/L. Moreover, the voltage in the above treatment is low, which reduces energy consumption.

The present invention further proposes an oil-gas-water separation method, which is performed by means of the oil-gas-water separation device 100 according to the present invention. The oil-gas-water separation method according to the present invention is briefly described as follows.

The produced fluid from the oil-gas wellhead enters the cyclone 7 tangentially from the liquid inlet 71. Due to the centrifugal force, the natural gas carrying small liquid droplets flows upwards into the separation pipe 80 for the primary liquid removal treatment. The natural gas after separation and removal of liquid enters the mist catcher 9. The separated liquid enters the secondary separation zone 11 through the return pipeline 82, and is mixed with the produced fluid entering the secondary separation zone 11 through the liquid inlet pipe 10. The natural gas entering the mist catcher 9 further undergoes liquid removal by the mist catcher 9, and is discharged from the gas outlet 92 at the top portion of the mist catcher 9, then flows to a natural gas pipeline network. The oil-water mixture is discharged from the liquid inlet pipeline 10 at the bottom portion of the cyclone 7 and enters the secondary separation zone 11. After the primary oil-water separation by the secondary separation mechanism 2, the separated oil is distributed into the oil buffer chamber 13 of the collection zone 40 through the oil collection pipe. The separated oily produced water flows from the outlet end of the secondary separation mechanism 2 to the water retaining space 23, and flows over the second partition plate 15 to enter the tertiary separation zone 12. The oily produced water undergoes the secondary oil-water separation (i.e., demulsification separation) through the tertiary separation mechanism 3 in the tertiary separation zone 12, and the separated oil flows over the third partition plate 16 to enter the oil buffer chamber 13 of the collection zone 40, and then is discharged into the oil discharge pipeline through the oil outlet 131 for collection. The purified produced water enters the water buffer chamber 14 of the collection zone 40 through the water distributing pipe 4, and is finally discharged into the water discharge pipeline through the water outlet 141.

The oil-gas-water separation device according to the present invention includes a primary separation mechanism, a secondary separation mechanism and a tertiary separation mechanism, so that the oil-gas field produced fluid entering the main container first undergoes the gas-liquid separation by the primary separation mechanism. The separated oil-water mixture undergoes the primary oil-water separation by the secondary separation mechanism, and then the secondary oil-water separation by the tertiary separation mechanism. The separated oil and water are respectively collected by the collection zone, thus completing the oil-gas-water separation of the produced fluid.

Said oil-gas-water separation device can perform multiple separations on the oil-gas field produced fluid with a high water separation efficiency, thus ensuring the separation effect. In the meantime, the oil-gas-water separation device, which has a compact structure and a small volume, can treat high foaming and emulsifying oil-gas field produced fluids with a crude oil density of less than 0.98 g/cm³ and a water content of more than 50%. With this oil-gas-water separation device, more than 50% of the water in the oil-gas field produced fluid can be separated. The oil content and the suspended matter content in the produced water are both less than 50 mg/L. Therefore, the oil-gas-water separation device according to the present invention can realize the on-site water separation for high foaming and emulsifying produced fluids in oil-gas fields.

It is readily understood that although the present invention is described above taking the oil-gas field produced fluid as an example, the oil-gas-water separation device according to the present invention may also be used to treat other similar fluid mixtures.

It should be understood that in the present invention, the terms “first” and “second” are used for illustrative purposes only, and are not intended to indicate or imply relative importance or implicitly specify the number of technical features indicated. Thus, the technical features defined with the terms “first” or “second” may explicitly or implicitly include one or more such technical features. In the description of the present invention, “a plurality of” means two or more, unless otherwise specified.

The phrases “an embodiment”, “some embodiments”, “example”, or the like, as mentioned in the description mean that the particular features, structures, materials or characteristics described in conjunction with the embodiment or example are included in at least one embodiment or example of the present invention. Thus, the above illustrative phrases described throughout the description do not necessarily refer to the same embodiment or example. Moreover, the particular features, structures, materials, or characteristics described herein may be combined in any one or more of the embodiments or examples in a suitable manner.

Finally, it should be noted that the foregoing description is merely illustrative of preferred embodiments of the present invention, and is not intended to restrict the present invention. Although the present invention is described in detail with reference to the above embodiments, it is still possible for one skilled in the art to modify the technical solutions defined in the above embodiments or to replace some of the technical features with equivalent ones. Any modifications, equivalent substitutions, improvements, and the like falling within the spirit and principles of the present invention are intended to be included within the scope of protection of the present invention.

1. An oil-gas-water separation device for an oil-gas field produced fluid, comprising:
a primary separation mechanism for a gas-liquid separation of the oil-gas field produced fluid, comprising a liquid inlet pipe, and a gas-liquid separation unit in communication with the liquid inlet pipe;
a main container, in which a secondary separation zone and a tertiary separation zone are formed, the liquid inlet pipe being in fluid communication with the secondary separation zone;
a secondary separation mechanism arranged in the secondary separation zone, for performing a primary oil-water separation on an oil-water mixture separated by the primary separation mechanism and entering the secondary separation zone; and
a tertiary separation mechanism arranged in the tertiary separation zone, comprising a three-dimensional electrode unit capable of generating an electric field to destabilize an oily produced water separated by the secondary separation mechanism, so as to perform a secondary oil-water separation on the oily produced water,
wherein the main container further comprises a collection zone for collecting the separated oil and water.

2. The oil-gas-water separation device according to claim 1, wherein the three-dimensional electrode unit is arranged on a mounting frame fixed at a bottom portion of the main container, and comprises a plurality of electrode plates spaced apart along a longitudinal direction, and a coalescence packing filled between adjacent electrode plates.

3. The oil-gas-water separation device according to claim 2, wherein two adjacent electrode plates are formed as an anode plate and a cathode plate respectively, wherein a surface of the cathode plate is provided with an insulating coating mixed with conductive filler, and a number of conductive protrusions.

4. The oil-gas-water separation device according to claim 3, wherein heights of the conductive protrusions relative to the surface of the cathode plate are different from each other.

5. The oil-gas-water separation device according to claim 2, wherein the mounting frame comprises a support portion fixed on the main container, and a support plate mounted on the support portion, wherein a plurality of inlet holes is formed on the support plate to allow the oily produced water to enter the three-dimensional electrode unit from a bottom portion to a top portion thereof.

6. The oil-gas-water separation device according to claim 5, wherein the support plate is further provided with a plurality of ultrasonic elements arranged irregularly, for generating an ultrasonic field.

7. The oil-gas-water separation device according to claim 1, wherein the gas-liquid separation unit is arranged at a top portion of the main container, comprising a cyclone connected to the liquid inlet pipe, a liquid inlet being formed on a side wall of the cyclone for receiving the oil-gas field produced fluid.

8. The oil-gas-water separation device according to claim 7, wherein a separation pipe is arranged at one end of the cyclone away from the liquid inlet pipe, and a cyclone grid filled with a separation packing is arranged in the separation pipe, wherein the cyclone and the cyclone grid are configured to perform a multi-stage liquid removal on the oil-gas field produced fluid.

9. The oil-gas-water separation device according to claim 8, wherein the separation pipe is arranged obliquely and comprises at least one return pipeline in communication with the secondary separation zone.

10. The oil-gas-water separation device according to claim 8, wherein the gas-liquid separation unit further comprises a mist catcher in communication with the separation pipe, wherein a packing layer is provided inside the mist catcher, and the fluid introduced into the mist catcher passes through the packing layer from a bottom portion to a top portion thereof for a mist removal to separate the gas, which is discharged through a gas outlet at the top portion of the mist catcher.

11. The oil-gas-water separation device according to claim 1, wherein the secondary separation mechanism comprises a separation shell arranged at a bottom portion of the secondary separation zone and extending along the longitudinal direction, and a flow channel formed inside the separation shell and filled with a diffusion packing, wherein the liquid inlet pipe extends to an inlet end of the flow channel.

12. The oil-gas-water separation device according to claim 11, wherein a first partition plate extending along a vertical direction is fixedly connected between the top portion of the main container and a top portion of the separation shell, and a second partition plate facing an outlet end of the flow channel is provided at the bottom portion of the main container, wherein the first partition plate and the second partition plate are spaced apart from each other and overlap each other along the vertical direction, forming a water retaining space therebetween, so that the oily produced water separated by the secondary separation mechanism enters the water retaining space and then flows over the second partition plate to enter the tertiary separation zone.

13. The oil-gas-water separation device according to claim 12, wherein the collection zone comprises an oil buffer chamber and a water buffer chamber, wherein a top portion of the secondary separation zone is in communication with the oil buffer chamber, and a top portion and a bottom portion of the tertiary separation zone are in communication with the oil buffer chamber and the water buffer chamber respectively.

14. The oil-gas-water separation device according to claim 13, wherein a third partition plate for separating the tertiary separation zone from the collection zone is fixed at the bottom portion of the main container, and a fourth partition plate for separating the oil buffer chamber from the water buffer chamber is fixed at a bottom portion of the collection zone, wherein heights of the second partition plate, the third partition plate and the fourth partition plate increase sequentially.

15. The oil-gas-water separation device according to claim 14, wherein the collection zone is provided with a substantially L-shaped water distributing pipe, which comprises a first pipe body and a second pipe body perpendicular to and in communication with each other, wherein the first pipe body is vertically fixed at a bottom portion of the water buffer chamber, with a height less than that of the fourth partition plate, and the second pipe body passes through the fourth partition plate and the third partition plate to extend into the tertiary separation zone.

16. The oil-gas-water separation device according to claim 15, wherein the water distributing pipe further comprises a regulator for adjusting a water level of the first pipe body.

17. An oil-gas-water separation method, which is performed by means of the oil-gas-water separation device according to claim 1.
